(19) United States
(12) Patent Application Publication
(10) Pub. No.: US 2026/0307088 A1
(43) Pub. Date: Oct. 8, 2026

(54) FLUID DISPENSER

(71) Applicant: APTAR ITALIA S.P.A., San Giovanni Teatino (CH) (IT)

(72) Inventor: Lamberto CARTA, Pescara (IT)

(21) Appl. No.: 18/996,714

(22) PCT Filed: May 24, 2023
(86) PCT No.: PCT/IB2023/055339

§ 371 Date: Jan. 17, 2025

(30) Foreign Application Priority Data
Jul. 21, 2022 (IT) 102022000015306

(51) Int. Cl. B05B 11/10; B05B 11/00

(52) U.S. Cl. CPC B05B 11/1035; B05B 11/0044; B05B 11/0089; B05B 11/1047; B05B 11/1059; B05B 11/1067

(57) ABSTRACT

FIG. 4B contained in a bottle, made of plastic material, comprising a ring nut (2), defining a receiving portion (5), and having a central tubular element (3) defining in turn a cylindrical conduit (4) for sucking the fluid; a concertina-like deformable element (6) comprising lateral walls (7) defining a dosing chamber (8); a dispensing head (9), which can be pressed by a user and equipped with a collection chamber (10) designed to collect the fluid flowing out from the dosing chamber (8). The concertina-like deformable element (6) comprises a lower tubular portion (11) axially slidable inside a first annular space (12), defined between the central tubular element (3) and the receiving portion (5) of the ring nut (2). The dispenser (1) also comprises a plurality of first ribs (24) and second ribs (25), respectively positioned on the receiving portion (5) and on the lower tubular element (11). The lower tubular portion (11) in a raised position of the dispensing head (9) guarantees the fluid-tight seal with the receiving portion (5). In the lowered position, the lower tubular portion (11) defines a passage for the flow of compensation air, which is distinct and separate from the dispensing conduit.

This invention relates to a dispenser for dispensing fluid. In other words, the invention relates to a dispensing device applicable to the neck of a bottle in order to dispense the fluid contained in the bottle.

There are various types of prior art dispensers, from those which are structurally complex to those which are structurally simpler.

Disadvantageously, these devices are often made of materials different from those of the bottles to which they are coupled and a user who is not very careful might not separate the dispenser from the bottle when disposing of the waste. In this way the recycling of the two components is not efficient and, especially when arriving in an area for sorting the waste, requires lengthy sorting times.

Generally speaking, the use of dispensers is known which are equipped with a simple structure and therefore with a reduced number of components so as to have environmentally-sustainable products equipped with homogeneous material in such a way as to simplify the recycling.

Of these, dispensers are commonly known which are based on concertina-like deformable elements which act as spring and delimit the dispensing chamber for the fluid flowing out. These elements may also integrate the non-return valves which regulate the infeed and outfeed of the fluid from the dosing chamber by suitably opening for specific pressure differences, with the advantage of reducing to a maximum the number of components used and the corresponding materials.

A drawback of these dispensers is due to the fact that some components, especially those which integrate various functions, have a poor versatility of use, and if they are designed to optimise the performance on the basis of the characteristics of a specific fluid to be dispensed, they are often unable to guarantee an adequate operation in the case of use of the dispenser with a fluid having different characteristics.

Often, some dispensers with this simplified structure do not have, disadvantageously, compensating systems and are not therefore able to top-up with air the volume of fluid extracted from the bottle as they are generally used for systems which do not require it.

Moreover, in some of them there are compensation systems which can be activated by a release mechanism which allows the activation of the dispenser, which would otherwise be impossible.

However, these systems have the major drawback of leaving channels for the flow of air which are constantly open once the dispenser is in the released configuration. In this condition, the package is not sealed and there may be accidental escape of liquid, through the channels for the flow of compensation air, if the bottle is overturned and/or squashed.

Lastly, the prior art dispensers require certain construction specifications in order to allow the transport in safety, which is a feature disadvantageously missing in the above-mentioned simplified structures.

The technical purpose of the invention is therefore to provide a dispenser for dispensing a fluid which is able to overcome the drawbacks of the prior art.

The aim of the invention is therefore to provide a dispenser for dispensing fluid which has a simplified structure which can be used in systems which require the presence of a compensation system for topping-up the volume of fluid extracted. A further aim of the invention is to provide a dispenser for dispensing fluid which has a degree of robustness such that it can be dispatched without particular protective devices.

A further aim of the invention is to provide a dispenser for dispensing fluid which has features such as to allow recycling in a safe fashion.

A further aim of this invention is also to provide a dispenser for dispensing fluid which allows a versatility of use of the dispenser with any type of fluid.

Lastly, the technical aim of the invention is to provide a dispenser which prevents the accidental escape of fluid from the package when the dispenser is unlocked and not actuated, through a system which allows the correct reintegration of the air exclusively during the stroke for actuating the dispenser.

The technical purpose indicated and the aims specified are substantially achieved by a dispenser for dispensing a fluid comprising the technical features described in one or more of the appended claims. The dependent claims correspond to possible embodiments of the invention.

Further features and advantages of the invention are more apparent in the non-limiting description which follows of a non-exclusive embodiment of a dispenser for dispensing a fluid.

The description is set out below with reference to the accompanying drawings which are provided solely for purposes of illustration without restricting the scope of the invention and in which:

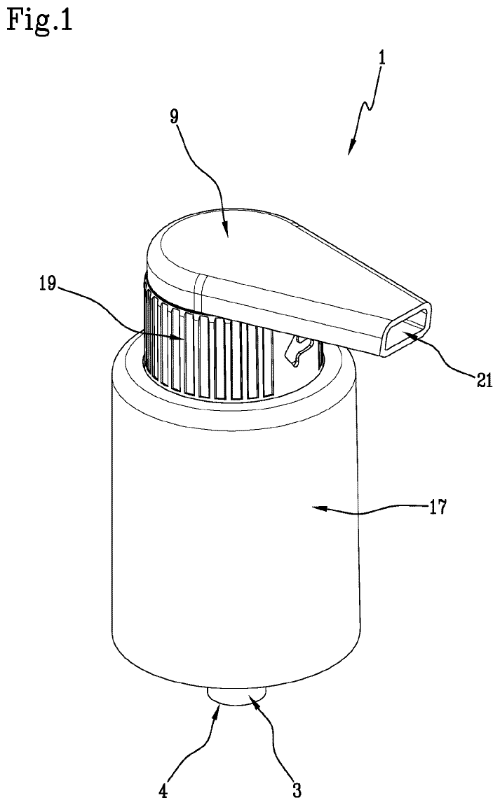

FIG. 1 is a schematic view of a perspective view of the dispenser according to the invention;

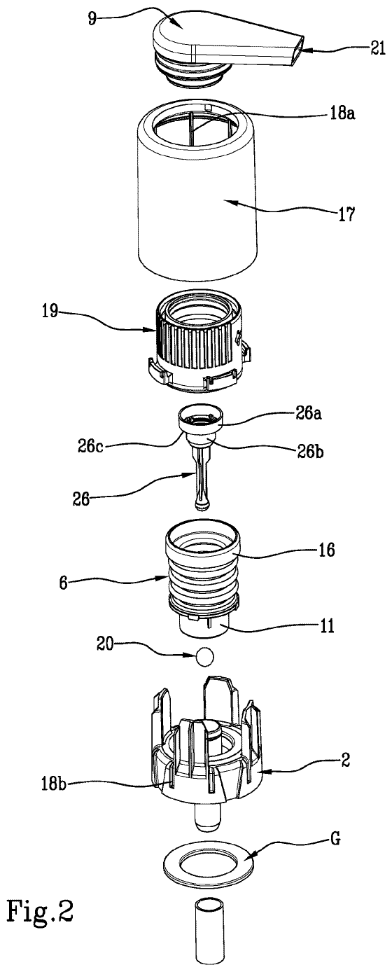

FIG. 2 is a schematic exploded view of an embodiment of the dispenser according to the invention;

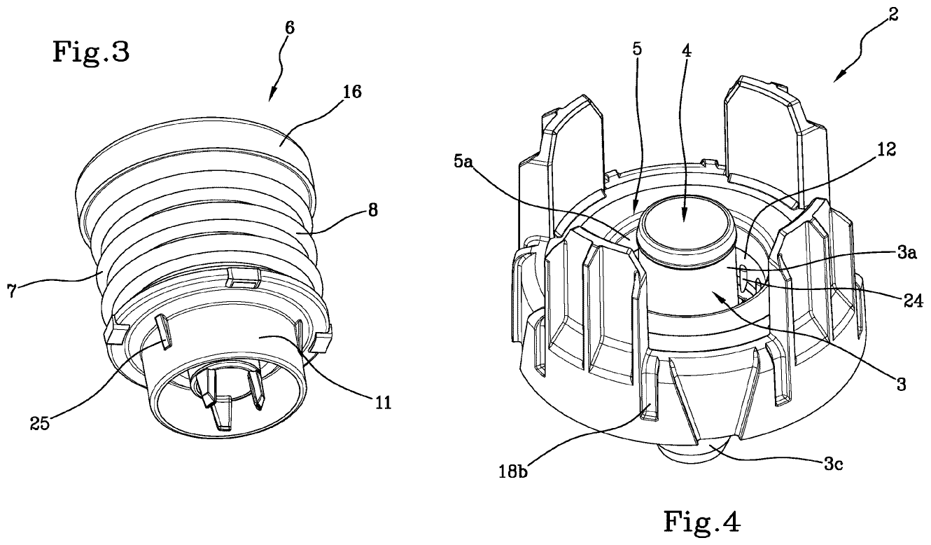

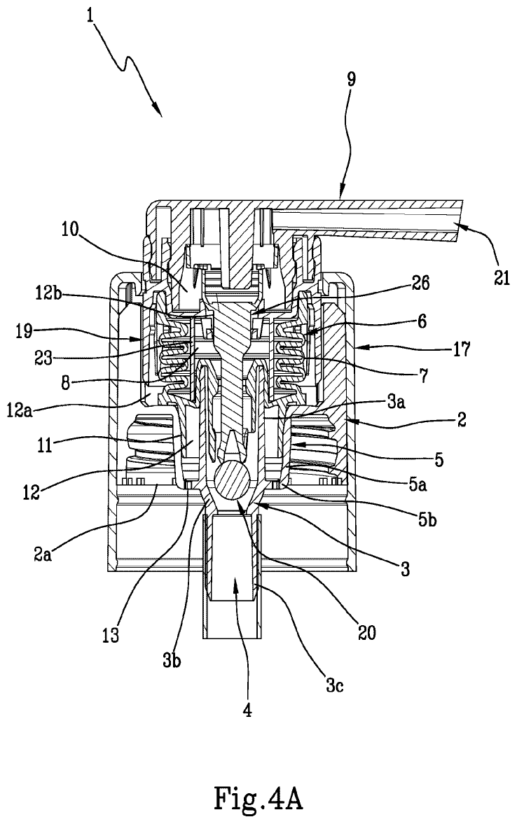

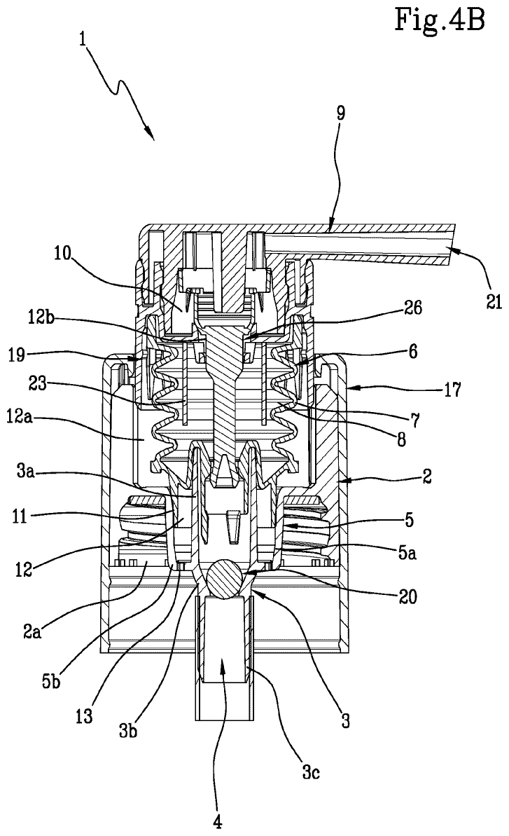

FIGS. 3 and 4 are perspective schematic views of components of the dispenser according to the invention;

FIGS. 4A and 4B are schematically views of two configurations of use of the dispenser according to the invention.

With reference to the accompanying drawings, the dispenser for dispensing a fluid contained in a bottle is denoted in its entirety as a dispenser 1.

The dispenser 1 is made of plastic material in such a way as to simplify the recycling. Preferably, the dispenser 1 is made of polyethylene. Even more preferably, the plastic material is a biological plastic produced from non-fossil sources. In other words, the components from which the dispenser 1 is made are sized in such a way as to be made from a single plastic family (for example, polyethylene) so that it can also be recycled together with bottles which, when not transparent, are also made of polyethylene.

Advantageously, in the polyethylene family there are the above-mentioned biological plastics (made from non-fossil sources) which are particularly recyclable and/or biodegradable.

The dispenser 1 comprises a ring nut 2 which can be screwed onto the neck of a bottle (not illustrated).

The ring nut 2 is equipped with an assembly portion which can be screwed onto the neck of the bottle. The accompanying drawings show the fastening system 2a made with a substantially cylindrical shape (defining the main body of the ring nut 2). The main body of the ring nut 2 has perimeter walls (in particular a single circular lateral wall) equipped internally with a thread designed to allow the screwing to the neck of the bottle. The threaded fastening system 2a may be replaced by other coupling systems (not illustrated) for bottles, for example snap-on systems or the like.

The dispenser 1 is also equipped with a seal element “G”, positioned inside the perimeter wall of the ring nut 2 to guarantee the seal with the bottle.

The ring nut 2 has a central tubular element 3a, suitably shaped internally, forming an axial conduit 4 for sucking the fluid. The central tubular element 3 is designed to allow the coupling of a draw-up pipe (not illustrated) for sucking the fluid from the bottle.

According to a possible embodiment of a dispenser 1 for dispensing fluid, as shown in the accompanying drawings, the central tubular element 3 has a neck 3b in an intermediate zone.

The neck 3b, preferably substantially having the shape of a circular ring, partly occludes the conduit 4.

The neck 3b is designed to interface with a first shutoff element 20. The first shutoff element 20 may preferably be made with a substantially spherical shape, as shown in the accompanying drawings.

In particular, the first shutoff element 20 is configured to be positioned resting on the neck 3b and to rise from it in such a way as to make together with the neck 3b a fluid check valve. In other words, the first shutoff element 20 may be made with any shape useful for making the above-mentioned check valve.

Alternatively, according to another possible embodiment of a dispenser 1 for dispensing fluid, the ring nut 2 has an orifice for sucking the fluid.

The orifice is positioned in a central portion of the ring nut 2 and is designed to allow the coupling of the draw-up (not illustrated) for sucking the product from the bottle. Preferably, the orifice is defined by the central tubular element 3.

The ring nut 2 also comprises, in both the embodiments proposed, a receiving portion 5 circumscribed around the central tubular element 3 in such a way as to delimit, between the central tubular element 3 and the receiving portion 5, a first annular space 12.

In more detail, the receiving portion 5 is cup-shaped with concavity facing upwards to form the annular space 12. Moreover, the receiving portion 5 engages with an intermediate portion of the central tubular element 3, dividing the latter into an upper portion 3a (delimiting the annular space 12) and a lower skirt 3c, facing towards the inside of the container and suitable for connection with the draw-up pipe.

As shown in the accompanying drawings, the central tubular element 3 is made integrally with the receiving portion 5, preferably the entire ring nut 2 being made in a single body.

The cup-shaped receiving portion 5, as for example shown in the accompanying drawings, is defined by a first wall 5a, substantially parallel to the central tubular element 3 and laterally delimiting the first annular space 12, and by a second wall 5b transversal to the first wall 5a and delimiting the bottom of the first annular space 12. In other words, the first wall 5a extends concentrically with the central tubular element 3 and the second wall 5b defines an annular element for connecting between the first wall 5a and the upper part 3a of the central tubular element 3.

For this reason, the first annular space 12 is delimited laterally by the first wall 5a and by the upper part 3a of the central tubular element 3, and below by the second wall 5b which connects the central tubular element 3 and the first wall 5a of the receiving portion.

The ring nut 2 has a series of through holes 13 for placing in fluid communication the first annular space 12 with the inside of the bottle.

The through holes 13 may be defined, as shown in the accompanying drawings, on the second wall 5b of the receiving portion 5.

As shown for example in the accompanying drawings, the dispenser 1 also comprises a collar 17 connected to the ring nut 2 in such a way as to transmit a rotational motion to the ring nut 2. The collar 17 and the ring nut 2 are connected to each other by portions 18a and 18b shaped to match each other. The portions 18a and 18b have a mainly axial extension.

In other words, the portion 18a of the collar 17 is inserted in a complementary fashion into the portion 18b of the ring nut 2.

The collar 17 is also equipped with one or more undercuts (defined in a lower portion of the collar 17) designed to improve the connection between the collar 17 and the ring nut 2.

According to an embodiment not illustrated, the dispenser 1 may not be equipped with the collar 17.

The dispenser 1 is also equipped with a concertina-like deformable element 6 (illustrated in detail in FIG. 3), defining a return spring of the dispenser 1.

The concertina-like deformable element 6 comprises a lower tubular portion 11, inserted or insertable partly inside the first annular space 12, and a concertina-like deformable lateral wall 7 integral with the lower tubular portion 11.

The lateral wall 7 of the concertina-like deformable element 6 defines a dosing chamber 8 of the dispenser 1, and at the same time constitutes a deformable element designed to define the return spring of the dispenser 1.

Preferably, the concertina-like deformable element 6 has a connecting stretch with the lower tubular portion 11 configured to define an opposing elastic deformation between the concertina-like deformable element 6 and the lower tubular portion 11.

The concertina-like deformable element 6 is configured to elastically maintain a stable configuration corresponding to a raised position of the lower tubular portion 11 relative to the first annular space 12.

According to a possible embodiment, as shown in FIG. 4A, during the use the pressure inside the dosing chamber 8 allows control of the first shutoff element 20 described above, and in particular of its movement.

More specifically, the first shutoff element 20 is configured to be positioned resting on the neck 3b and to rise in the case of negative pressures of the dosing chamber 8, thus allowing the extraction of the fluid from the bottle.

Also, when it closes against the neck 3b, the first shutoff element 20 occludes the conduit 4, preventing the fluid from returning from the dosing chamber 8 to the bottle.

In this way, the first shutoff element 20 forms, together with the neck 3b, a non-return valve for the fluid at the infeed of the dosing chamber 8.

For this reason, the first shutoff element 20 may be made with any shape which allows the occlusion of the neck 3b and which therefore allows the opening and closing of the check valve described above as a function of the pressures exerted on the first shutoff element 20.

The lower tubular portion 11, according to a second embodiment, not illustrated, is equipped with a dome-shaped element which rests on the orifice forming an inlet valve for the product. Preferably, the dome-shaped element is connected by wire-like elements to a conical element of the concertina-like deformable element 6. The combination of the wire-like elements and the concertina-like deformable element 6 allow the dome-shaped element to be correctly positioned relative to the orifice of the ring nut 2 (that is, of the central tubular element 3).

In particular, the internal pressure of the dosing chamber 8 allows the control of the dome-shaped element described above. More specifically, the dome-shaped element is designed to rise in the case of negative pressures in the dosing chamber 8. By opening, the dome-shaped element allows the extraction of the product from the bottle.

The concertina-like deformable element 6 may have, in both embodiments, an upper portion 16 configured to be coupled to a ring 19.

The ring 19 is located on the ring nut 2 and configured to define with the ring nut 2 a locking system designed to define an operating configuration and a non-operating configuration of the dispenser 1.

The term “operating configuration” means a configuration wherein the dispenser 1 can be actuated and is able to dispense the fluid drawn from the bottle.

The term “non-operating configuration” means a configuration wherein the dispenser 1 cannot be actuated and is therefore not able to dispense the fluid.

In particular, the ring 19 is able to define the two above-mentioned configurations by means of a reciprocal rotation between the ring 19 and the ring nut 2.

The dispenser 1 may be controlled by a user in such a way as to allow a dispensing head 9, slidably coupled to said ring nut 2 by means of said ring 19, and connected below to said concertina-like deformable element 6, again by means of said ring 19, to adopt an operating configuration and a non-operating configuration.

The term “operating configuration” (FIG. 4a) means a configuration of the dispensing head 9, when the dispenser 1 is in the operating configuration, wherein it is pressed and consequently moved from a raised position to a lowered position relative to the bottle in such a way that the fluid is dispensed by the dispenser 1 through an outlet channel (21).

In said lowered position, the concertina-like deformable lateral wall 7 is axially compressed.

Consequently, the lower tubular portion 11 of the concertina-like deformable element 6 adopts a lowered position inside the first annular space 12 following the lowering of the dispensing head 9.

Moreover, the term “non-operating configuration” (FIG. 4B) means a configuration of the dispensing head 9, both when the dispenser 1 is in the operating configuration and when it is in the non-operating configuration, wherein the dispensing head 9 is left still in the raised position relative to the bottle and the concertina-like deformable lateral wall 7 is axially extended (in other words, the dispensing head 9 is not pressed and the fluid is not dispensed).

In particular, the dispensing head 9 is equipped with a collection chamber 10 designed to collect and dispense the fluid flowing out from the dosing chamber 8 of the concertina-like deformable element 6 through a central opening 12b which places in communication the dosing chamber 8 and the collection chamber 10.

The central opening 12b is configured to define, together with a second shutoff element 26 a further non-return valve which operates on the delivery of the fluid from the dosing chamber 8 to the collection chamber 10.

More specifically, the second shutoff element 26 is integral with the dispensing head 9 and is movably housed in the central opening 12b of the ring 19.

In particular, the second shutoff element 26 has an anchoring portion 26a, preferably annular, designed to be stably received in a receiving portion of the dispensing head 9 in such a way as to make the second shutoff element 26 integral with the dispensing head 9.

Moreover, the second shutoff element 26 has a sealing portion 26b, having a substantially elongate shape and designed to occlude the central opening 12b, forming a closed configuration of the delivery valve.

The second shutoff element 26 also has a connecting portion 26c, joining the sealing portion 26b to the anchoring portion 26a and configured to allow the movement, by elastic deformation, of the sealing portion 26b relative to the anchoring portion 26a in such a way as to open the delivery valve in the case of a pressure of the dosing chamber 8 greater than the predetermined threshold value. According to a second embodiment, the portion 16 of the concertina-like deformable element 6 is equipped with a sealing lip designed to open in the case of a pressure of the dosing chamber 8 greater than a predetermined threshold value.

The sealing lip replaces, to all intents and purposes, the second shutoff element 26.

Preferably, the sealing lip is configured to open when the pressure in the dosing chamber 8 exceeds a threshold value of between 400 and 600 mbar.

Even more preferably, the sealing lip is configured to open when the pressure in the dosing chamber 8 exceeds a threshold value of 600 mbar.

The concertina-like deformable lateral wall 7, in both the embodiments illustrated, defines internally the dosing chamber 8 and externally a second annular space 12a between the ring nut 2 and the lateral wall 7.

Preferably, the ring 19 (that is to say, the dispensing head 9, according to an alternative embodiment in which the ring 19 and the dispensing head 9 are made as one piece) comprises one or more axial protrusions 23 extending axially inside the dosing chamber 8 and configured for entering into contact with the concertina-like deformable element 6.

The axial protrusions 23 transfer a flattening force from the dispensing head 9 to the lower tubular portion 11, promoting the reaching of the lowered position by the lower tubular portion 11.

Advantageously, the lower tubular portion 11 of the concertina-like deformable element 6 is axially slidable inside the first annular space 12 following said pressure of the dispensing head 9.

In a raised position of the dispensing head 9, the lower tubular portion 11 forms a fluid-tight seal with the receiving portion 5 isolating the first annular space 12. In other words, the lower tubular portion 11 isolates the first annular space 12 preventing the passage of the compensation air.

In the lowered position, the lower tubular portion 11 defines a passage for a flow of compensation air, distinct and separate from the dispensing conduit formed by the drawing conduit 4, for placing in communication the first and the second annular spaces. In other words, the lower tubular portion 11 deforms in such a way as to allow the passage of air between the second annular space 12a and the first annular space 12 as well as through the through holes 13.

The passage of the air flow between the second annular space 12a and the volume of the container, so that compensation is guaranteed, occurs thanks to the through holes 13 which are permanently open and to the first annular space 12.

Preferably, the lower tubular portion 11 is radially and elastically deformable. In that way, in the lowered position of the dispensing head 9, at least one elastically deformed portion of the lower tubular portion 11 defines the passage for the flow of air.

In a rest condition, the concertina-like deformable element 6 is in the raised position, that is to say, not resting on the “flange” of the ring nut 2, in such a way as to allow an axial sliding downwards of the lower tubular portion 11 in its receiving portion 5 located on the ring nut 2, when the concertina-like deformable element 6 is compressed by the operating thrust of a user.

The sliding at the same time generates an opposing elastic deformation of the connecting stretch, such as to return the lower tubular portion 11 to its raised initial condition, when the pushing action of the user is removed and the concertina-like deformable element 6 returns to its rest configuration.

This sliding also allows the opening of one or more passages (connecting channels), to allow the topping up of air in the bottle which compensates for the escape of the liquid dispensed.

The lower tubular portion 11 of the concertina-like deformable element 6 and the receiving portion 5 of the ring nut 2 comprise a plurality of ribs.

The ribs 24, present on the receiving portion 5, are positioned inside the receiving portion 5.

The ribs 25, present on the lower tubular portion 11, are positioned outside the lower tubular portion 11.

According to the accompanying drawings, the ribs are present both on the lower tubular portion 11 of the concertina-like deformable element 6 and on the receiving portion 5 of the ring nut 2.

The ribs 24, 25 are configured for making, following the pressure of the dispensing head 9 and a corresponding sliding of the lower tubular portion 11 with respect to the receiving portion 5, a localised deformation of at least one region of the lower tubular portion 11, defining the passage for the flow of air.

Moreover, the ribs 24, 25 are angularly distributed, preferably equidistant, about an axis of extension of the central tubular element 3.

The ribs 24, 25, in a raised position of the dispensing head 9, are preferably located axially outside a cylindrical superposing area between the lower tubular portion 11 and the receiving portion 5. In other words, in the raised portion of the dispensing head 9 (FIG. 4B) the ribs 24, 25 are not interposed between the lower tubular portion 11 and the receiving portion 5, allowing the two portions to maintain the contact which guarantees the airtight seal.

Preferably, the ribs 24, positioned on the receiving portion 5, are positioned in such a way as to face inside the first annular space 12 in the raised position of the dispensing head 9.

The ribs 24 are also disengaged from the lower tubular portion 11 and in particular positioned below a lower edge of the lower tubular portion 11.

Alternatively, in the raised position of the dispensing head 9, the ribs 25, positioned on the lower tubular portion 11, face the second annular space 12a and are positioned above the receiving portion 5.

In short, said ribs comprise first ribs 24 positioned on the receiving portion 5, facing the first annular space 12 and second ribs 25 positioned on the lower tubular portion 11 facing the second annular space 12a (when the dispenser 1, that is, the dispensing head 9, are in the raised position). In this case, the first ribs 24 are disengaged from the lower tubular portion 11 and the second ribs 25 are positioned above the lower tubular portion 11 and disengaged from the receiving portion 5.

The first ribs 24 are axially spaced from the second ribs 25 at least in the raised position of the dispensing head 9.

Preferably, each of the first ribs 24 is angularly alternated with a pair of second ribs 25.

Alternatively, each of the second ribs 25 is angularly alternated with a pair of first ribs 24.

The plurality of ribs comprises, preferably, at least two first ribs 24 and at least one second rib 25 angularly alternated with the first ribs 24.

The first ribs 24 may be defined on the receiving portion 5 and the second rib 25 defined on the lower tubular portion 11 or vice versa.

In this way, the first ribs 24 and the second ribs 25 do not obstruct each other, defining in effect a plurality of passages for the compensation air.

Advantageously, the dispenser 1 described above is able to overcome the drawbacks of the prior art.

Advantageously, the dispenser 1 described above allows a facilitated recycling due to the material with which the dispenser 1 is made.

Advantageously, the dispenser 1 according to the invention has strength properties such as to allow safe dispatch without the use of special protective devices.

Advantageously, the dispenser 1 according to the invention has features such as to guarantee the fluid-tight seal and the formation of at least one passage for a flow of compensation air independent of an angular position adopted by the dispensing head 9 relative to the ring nut 2.

1. A dispenser (1) for dispensing a fluid contained in a bottle, made of plastic material, comprising:
a ring nut (2) comprising an assembly portion which can be screwed on the neck of a bottle, and a central tubular element (3) defining a conduit (4) for drawing fluid from said bottle, said ring nut (2) also comprising a receiving portion (5), positioned around said central tubular element (3) in such a way as to define a first annular space (12) between said central tubular element (3) and said receiving portion (5), said ring nut (2) also having a series of through holes (13) for putting in fluid communication said annular space with the inside of said bottle;
a concertina-like deformable element (6), defining a return spring of said dispenser (1), comprising a lower tubular portion (11) and a concertina-like deformable lateral wall (7) integral with said lower tubular portion (11), said concertina-like deformable lateral wall (7) defining internally a dosing chamber (8) of said dispenser (1) and externally a second annular space (12a) between said ring nut (2) and said concertina-like deformable lateral wall (7), said lower tubular portion (11) being inserted in said first annular space (12) and coupled to said receiving portion (5) of the ring nut (2);
a dispensing head (9), slidably coupled to said ring nut (2) and connected below to said concertina-like deformable element (6), and provided with a channel designed to collect the fluid at the outlet from said dosing chamber (8) of said concertina-like deformable element (6) and dispense it through an outlet channel (21), said dispensing head (9) being pressable by a user between a raised position wherein the concertina-like deformable lateral wall (7) is axially extended, and a lowered position, wherein the concertina-like deformable lateral wall (7) is axially compressed;
a plurality of first ribs (24) and second ribs (25), respectively positioned in said receiving portion (5) and in said lower tubular portion (11) of the concertina-like deformable element (6);
said lower tubular portion (11) of the concertina-like deformable element (6) being axially slidable inside said first annular space (12) following a sliding of the dispensing head (9) between the raised and lowered positions;
said lower tubular portion (11) defining, in said raised position of the dispensing head (9), a fluid-tight seal with said receiving portion (5) isolating the first annular space (12) from the second annular space (12a), and also defining, in said lowered position of the dispensing head (9), at least one passage for a flow of compensation air, distinct and separate from the drawing conduit (4), for putting in communication with each other said first and second annular spaces (12a); and
characterised in that said plurality of first ribs (24) and said plurality of second ribs (25) are axially integral with said dispensing head (9) and configured for forming, following a pressure of the dispensing head (9) and a corresponding sliding of the lower tubular portion (11) relative to the receiving portion (5), a localised deformation of at least one region of the lower tubular portion

(11) defining at least one elastically deformed portion.

2. The dispenser (1) according to claim 1, wherein said first ribs (24) and second ribs (25) are positioned in a position axially outside a cylindrical superposing area between said lower tubular portion (11) and said receiving portion (5) in said raised position of the dispensing head (9).

3. The dispenser (1) according to claim 1, wherein said first ribs (24) are positioned on said receiving portion (5) and face inside the first annular space (12) and, in said raised position of the dispensing head (9), said first ribs (24) are disengaged from the lower tubular portion (11) and in particular positioned below a lower edge of the lower tubular portion (11).

4. The dispenser (1) according to claim 1, wherein said second ribs (25) are positioned on said lower tubular portion (11) and facing the receiving portion (5) and, in said raised position of the dispensing head (9), said second ribs (25) are positioned above said receiving portion (5).

5. The dispenser (1) according to claim 1, wherein said first ribs (24) and second ribs (25) are angularly distributed, preferably equidistant, about an axis of extension of the central tubular element (3).

6. The dispenser (1) according to claim 5, wherein said first ribs (24) are axially spaced from the second ribs (25) at least in said raised position of the dispensing head (9).

7. The dispenser (1) according to claim 5, wherein each of said first ribs (24) is angularly alternated with a pair of second ribs (25) or wherein each of said second ribs (25) is angularly alternated with a pair of first ribs (24).

8. The dispenser (1) according to claim 1, wherein said concertina-like deformable element (6) is configured to elastically maintain a stable configuration corresponding to a raised position of the lower tubular portion (11), said lower tubular portion (11) adopting a lowered position in said first annular space (12) following a lowering of the dispensing head (9).

9. The dispenser (1) according to claim 8, wherein said dispensing head (9) comprises one or more axial protrusions (23) extending axially inside the dosing chamber (8) and configured to make contact with the concertina-like deformable element (6) and transfer a flattening force from the dispensing head (9) to the lower tubular portion (11) promoting the reaching of the lowered position by the lower tubular portion (11).

10. The dispenser (1) according to claim 1, wherein said fluid-tight seal and said formation of at least one passage for a flow of compensation air are independent of an angular position adopted by the dispensing head (9) with respect to the ring nut (2).

11. The dispenser (1) according to claim 1, wherein said dispensing head (9) is coupled to said ring nut (2), and connected below to said concertina-like deformable element (6), by means of a ring (19) configured to define with the ring nut (2) a locking system designed to define an operating configuration and a non-operating configuration in which the dispenser (1) can or cannot, respectively, be actuated for dispensing the fluid drawn from the bottle, preferably said operating and non-operating configurations being switchable by means of a rotation of said ring (19).

12. The dispenser (1) according to claim 11, wherein said ring (19) comprises one or more axial protrusions (23) extending axially inside the dosing chamber (8) and configured for making contact with the concertina-like deformable element (6) and transferring a flattening force from the dispensing head (9) to the lower tubular portion (11) promoting the reaching of the lowered position by the lower tubular portion (11).
